(19) United States
(12) Patent Application Publication
(10) Pub. No.: US 2022/0408155 A1
(43) Pub. Date: Dec. 22, 2022

(54) SYSTEM AND METHOD FOR PROVIDING MEDIA CONTENT

(71) Applicant: Miappi Limited, London (GB)

(72) Inventors: Andrew Foyle, London (GB); Toby Britton, London (GB); Lee Buchanan, London (GB)

(21) Appl. No.: 17/844,500

(22) Filed: Jun. 20, 2022

(30) Foreign Application Priority Data
Jun. 21, 2021 (GB) GB2108863.8

(51) Int. Cl. H04N 21/462; H04L 65/60; H04N 19/103

(52) U.S. Cl. CPC H04N 21/4622; H04L 65/60; H04N 19/103

(57) ABSTRACT

Disclosed is a server arrangement for providing media content to a user device. The server arrangement is configured to identify a plurality of items of media content from at least one data source related to the service request; analyse the plurality of items of media content to determine values of pertinence indicators for each of the plurality of items of media content; determine a quality prediction score for each of the plurality of items of media content, wherein the quality prediction score for items of media content is determined based on values of pertinence indicators for the media content; provide a filtered set of items of media content to the user device, in response to the service request, wherein the set of items of media content comprises at least one item of media content having a quality prediction score higher than a predefined threshold.

### TECHNICAL FIELD

The present disclosure relates generally to media content; and more specifically, to systems and methods for providing media content to a user device.

### BACKGROUND

In recent years, marketing of entities has shifted to electronic mediums owing to greater impact of such electronic mediums and wide accessibility thereof. Notably, marketing of entities (such as, commodities (for example, products, services, and the like), brands, and so forth) via electronic mediums is an effective way to attract, engage and reward customers online (namely, digital marketing). Subsequently, suitable and appropriate media content plays a crucial role in effective digital marketing of entities.

Moreover, digital marketing of entities using existing media content (for example, Native advertising, marketing using Influencers, and the like) has become increasingly influential owing to higher availability thereof. However, volume of media content collected from the Internet for such digital marketing is very large, sometimes running into millions of posts and images. Moreover, searching for most suitable and appropriate media content for marketing of an entity from the collected media content is extremely challenging owing to the large volume of media content on the web. Such large volumes of media content presents a challenge for human moderators who need to review/access media content this inadvertently leads to large volumes of media content left unmoderated thereby missing out on the true potential value of the media for effective digital marketing.

Conventionally, such searching for suitable media content and selection thereof is performed by manual visual inspection of large volumes of media content acquired from the Internet. These large volumes of media content must be served to a human moderator for review. As such, a great deal of manual effort is dedicated in searching for the most suitable and appropriate media content. Such manual effort, usually performed by a professional or human moderator, drastically increases time for curation and moderation of media content thereby making the entire process slow to operate. Such manual inspection increases a number of costs/overheads of marketing of the entity, including the cost of the human moderator themselves, as well as the network/infrastructure/processing costs associated with curating a large volume of media content.

Moreover, the quality of the media content selected for marketing of the entity is inconsistent owing to a dependency on the individual skills and biases of the professional. A human moderator is also unlikely to be able to pick up nuances such as how similar media content have performed in the past. If human moderators had to cross-reference each social media post with data, such as the associated number of views and followers, then the process becomes even slower.

Therefore, in light of the foregoing discussion, there exists a need to overcome the aforementioned drawbacks associated with the conventional systems for determining the suitability of media content for the digital marketing of entities.

### SUMMARY

The present disclosure seeks to provide a system for providing media content to a user device. The present disclosure seeks to provide a solution to the existing problem of manual inspection of large volumes of media content for selection of suitable media content for use. An aim of the present disclosure is to provide a solution that overcomes at least partially the problems encountered in prior art, and provides a system that automatically analyses large volumes of media content from the Internet to determine a subset of items of media content comprising best quality media content, for effective use thereof.

In one aspect, an embodiment of the present disclosure provides a server arrangement for providing media content to a user device, wherein the server arrangement is configured to execute machine readable instructions that cause the server arrangement to:
in response to a service request from the user device, identify a plurality of items of media content from at least one data source related to the service request;
analyse the plurality of items of media content to determine values of pertinence indicators for each of the plurality of items of media content;
determine a quality prediction score for each of the plurality of items of media content, wherein the quality prediction score for items of media content is determined based on values of pertinence indicators for the media content;
provide a filtered set of items of media content to the user device, in response to the service request, wherein the set of items of media content comprises at least one item of media content having a quality prediction score higher than a predefined threshold.

In another aspect, an embodiment of the present disclosure provides a method for providing media content to a user device, wherein method comprises:
in response to a service request from the user device, identifying a plurality of items of media content from at least one data source related to the service request;
analysing the plurality of items of media content to determine values of pertinence indicators for each of the plurality of items of media content;
determining a quality prediction score for each of the plurality of items of media content, wherein the quality prediction score for items of media content is determined based on values of pertinence indicators for the media content;
providing a filtered set of items of media content to the user device, in response to the service request, wherein the set of items of media content comprises at least one item of media content having a quality prediction score higher than a predefined threshold.

In yet another aspect, an embodiment of the present disclosure provides a computer program product comprising non-transitory computer-readable storage media having computer-readable instructions stored thereon, the computer-readable instructions being executable by a computerized device comprising processing hardware to execute the aforesaid method.

Embodiments of the present disclosure substantially eliminate or at least partially address the aforementioned problems in the prior art, and enables automated value judgement regarding selection of media content from large volume of media content thereby significantly reducing moderation time, curation time, manual effort and human intervention in selection of the media content.

Additional aspects, advantages, features and objects of the present disclosure would be made apparent from the drawings and the detailed description of the illustrative embodiments construed in conjunction with the appended claims that follow.

It will be appreciated that features of the present disclosure are capable of being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a server arrangement for providing media content to a user device, in accordance with an embodiment of the present disclosure; and

FIG. 2 illustrates steps of a method for providing media content to a user device, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a server arrangement for providing media content to a user device, wherein the server arrangement is configured to execute machine readable instructions that cause the server arrangement to:
in response to a service request from the user device, identify a plurality of items of media content from at least one data source related to the service request;
analyse the plurality of items of media content to determine values of pertinence indicators for each of the plurality of items of media content;
determine a quality prediction score for each of the plurality of items of media content, wherein the quality prediction score for items of media content is determined based on values of pertinence indicators for the media content;
provide a filtered set of items of media content to the user device, in response to the service request, wherein the set of items of media content comprises at least one item of media content having a quality prediction score higher than a predefined threshold.

In another aspect, an embodiment of the present disclosure provides a method for providing media content to a user device, wherein method comprises:
in response to a service request from the user device, identifying a plurality of items of media content from at least one data source related to the service request;
analysing the plurality of items of media content to determine values of pertinence indicators for each of the plurality of items of media content;
determining a quality prediction score for each of the plurality of items of media content, wherein the quality prediction score for items of media content is determined based on values of pertinence indicators for the media content;
providing a filtered set of items of media content to the user device, in response to the service request, wherein the set of items of media content comprises at least one item of media content having a quality prediction score higher than a predefined threshold.

In yet another aspect, an embodiment of the present disclosure provides a computer program product comprising non-transitory computer-readable storage media having computer-readable instructions stored thereon, the computer-readable instructions being executable by a computerized device comprising processing hardware to execute the aforesaid method.

The system for determining values of pertinence indicators for media content provides a platform that identifies influential media content available over the web (namely, the Internet). Such identification of influential media content plays a vital role in, for example, digital marketing and advertisement of products, services, brands and the like. Specifically, the system determines most advantageous media content for a user (for example, a brand representative or content moderator) from numerous media content available on the Internet by anticipating effectiveness of each media content available on the Internet for the user. The system filters the media content to provide the user with those only items anticipated to have an effectiveness above a predefined threshold.

In this way, the system provides human moderators, i.e. the users who are operating the system, with smaller subset of items of media content comprising best quality media content from large volumes of media content acquired from the web. The system can significantly reduce the amount of data that is provided to the user, by filtering the large volume of available media content to only the best quality items. As such, the system can reduce network traffic, as well as the storage requirements and processing requirements to receive, store and display the media content on the user device.

The system can substantially decrease human intervention in determining influential media content thereby avoiding erroneous results due to biased decision and/or prejudices. Additionally, the system aims to save manual effort utilized in such determination of influential media content thereby making the process less time-consuming for the user. Beneficially, employing the system for determining influential media content for a user reduces curation time by automatically making a value judgement and assigning quality score to large volumes of media content from the web; and further yields the most favourable and appropriate results for the user without involving human biases and manual time and effort. Therefore, the system enables the user to derive better results by re-formatting media content utilized thereby for, for example, digital marketing, endorsement, and advertisement.

The system comprises the server arrangement. The term “server arrangement” refers to a structure and/or module that include programmable and/or non-programmable components configured to store, process and/or share information. The server may include any arrangement of physical or virtual computational entities capable of enhancing information to perform various computational tasks. Furthermore, it should be appreciated that the server may be both single hardware server and/or plurality of hardware servers operating in a parallel or distributed architecture. In an example, the server may include components such as memory, a processor, a network adapter and the like, for operation thereof with other computing components, such as user device. The server may be implemented as a computer program that provides various services (such as database service) to other devices, modules or apparatus.

Moreover, the term “user device” refers to an electronic device associated with (or used by) a user that is capable of enabling the user to perform specific tasks associated with the aforementioned system. Furthermore, the user device is intended to be broadly interpreted to include any electronic device that may be used for voice and/or data communication over a wireless communication network. Examples of user device include, but are not limited to, cellular phones, personal digital assistants (PDAs), handheld devices, wireless modems, laptop computers, and personal computers.

The server arrangement is communicably coupled to the user device. In this regard, the server arrangement is communicably connected to the user device via a data communication network. Moreover, the term “data communication network” refers to individual networks, or a collection thereof interconnected with each other and functioning as a single large network. Such data communication network may be implemented by way of wired communication network, wireless communication network, or a combination thereof. It will be appreciated that physical connection is established for implementing the wired network, whereas the wireless network is implemented using electromagnetic waves. Examples of such data communication network include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, fifth generation (5G) telecommunication networks, Worldwide Interoperability for Microwave Access (WiMAX), and different generation of Wireless access (Wi-Fi a, b, an, ac, ax) networks.

The server arrangement is configured to execute machine-readable instructions. It will be appreciated that ‘machine-readable instructions’ refer to data or information that is stored in a format that can be easily processed by an electronic device (for example, a computer, a magnetic stripe reader, a disk drive, a scanner, and the like). Pursuant to embodiments of present disclosure, the machine-readable instructions are processed by the server arrangement for interpretation and manipulation of a functioning thereof. The machine-readable instructions may be stored electronically as a bar code, a digital file written in magnetic ink, a digital file recorded on a disk, and so forth. The machine-readable instructions may be structured in nature. In an example, the machine-readable instructions are stored as at least one digital file, wherein the at least one digital file is in HTML format.

The server arrangement receives the service request from the user device. Notably, the service request refers to a request for data or information from a storage device (for example, local databases, cloud databases, or a combination thereof). It will be appreciated that a service request comprises at least one entity, wherein the at least one entity may be a word, a symbol, a special character, a phrase, an image, a video, a sound, and the like. In an example, the service request may be name of a brand, image of a logo, name of a product, name of a service, a hashtag, a geographical location, a slogan, a phrase, an acronym, a social media slang, a social media post, and the like.

The service request may comprise special characters and/or symbols, for example, :, ;, @, #, *, &, +, ? and the like. The service request may be structured or unstructured (such as, plain text, hypertext, and the like). In this regard, the server arrangement structures the unstructured service request for processing thereof.

The service request may be initiated by a user, employing the user device. In this regard, the user may be a person or a bot operating the user device. For example, the user is a person associated with a product, a service, a brand, and so forth. In this regard, the user may be marketing personnel, advertising personnel, representative, ambassador, campaigner, promoter, and the like.

The server arrangement identifies the plurality of items of media content from at least one data source related to the service request. In this regard, the term “media content” refers to information that is directed towards an audience, for example, a network of recipients. The media content may be expressed through a medium, for example: speech, writing, art, music, photograph, video, and the like. The media content may exist in form of digital data, wherein the digital data is stored in an electronic medium. Additionally, the media content can be delivered to the audience by employing Internet, Television, Radio, Smartphones, books, e-books, magazines, live events, and the like. It will be appreciated that the plurality of items of media content may be stored in different formats, wherein a format of a media content may be text, image file, video file, audio file, animation file and so forth.

Examples of the media content include, but are not limited to, e-books, contributor-generated content (such as social media post, comment, rating, review, message, and so forth), visual content, podcasts, LIVE streams, webinars, testimonials, infographic content, and interactive content.

Furthermore, the plurality of items of media content related to the service request is identified from the at least one data source. Specifically, the term “data source” refers to a location from where data is extracted. The at least one data source may be a database, a file, a dataset, a spreadsheet, an XML or JSON file, a hard-coded data within the server arrangement, an IoT or wearable device, or a combination thereof. The at least one data source may be located in a local disk or at a remote server. Pursuant to embodiments of the present disclosure, the server arrangement identifies the plurality of items of media content related to the service request. Subsequently, the plurality of items of media content are identified from the at least one data source, where they are stored. In an example, the at least one data source is a database of a social media platforms, for example, Facebook®, Instagram®, LinkedIn®, Pinterest®, Snapchat®, Twitter®, Tik Tok® and the like.

The server arrangement may extract the identified plurality of media content and stores thereto in a local memory. Beneficially, storing the plurality of items of media content in the local memory of the server arrangement enables optimization of run-time of the system by enabling quick access to the plurality of items of media content for performing parallel operations thereon.

The server arrangement may determine pertinence indicators for each of the plurality of items of media content. The term “pertinence indicators” refer to factors that define competency of a media content. Specifically, the pertinence indicators are parameters that are used to define a value or reliability of a given media content. The pertinence indicators may be based on the type of the media content, for example, the pertinence indicators for the given media content depends on a format of the given media content. It will be appreciated that the pertinence indicators for the given media content from the plurality of items of media content may differ from pertinence indicators for another media content from the plurality of items of media content.

In an example, a given media content may be a social media post. In such case, pertinence indicators for the given media content may include, but are not limited to, gender of followers of a contributor of the given media content on the social media, gender of people followed by the contributor of the given media content on the social media, geographical regions of followers of a contributor of the given media content on the social media, geographical regions of people followed by the contributor of the given media content on the social media, number of followers of a contributor of the given media content on the social media, number of people followed by the contributor of the given media content on the social media, a ratio of followers to followed, number of third-party interactions (namely, comments) with the given media content, number of likes for the given media content, number of dislikes for the given media content, a quality or resolution of the given media content, a sentiment (negative, neutral or positive) of audience interactions with the given media content, social acceptance of the given media content, compliance of the given media content with social media rules, value of the given media content on other social media platforms, format of the given media content and whether it comprises of visual media (e.g. image, video, animation). Pertinence indicators may include individual criteria introduced by the user such as e.g. text rules set by the user. Pertinence indicators may be automatically updated based on the analysis of historic performance of associated items of media content and the relevance of the pertinence indicators used (namely, how accurate were the predictions based on the given pertinence indicator).

The server arrangement analyses the plurality of items of media content to determine values of pertinence indicators for each of the plurality of items of media content. It will be appreciated that each of the plurality of items of media content has pertinence indicators associated thereto, wherein pertinence indicators for the given media content is specific thereto. Subsequently, the server arrangement analyses the given media content in regard with the pertinence indicators associated therewith. Such analysis of the given media may include requesting and/or retrieving values of pertinence indicators from one or more of the data sources.

Such analysis of the given media content is employed by the server arrangement to determine a value for each of the pertinence indicators for the given media content. Values determined for the pertinence indicators may be numeric values, wherein the numeric values lie on a scale of 0 to 1. In this regard, a value ‘0’ denotes a lowest value for a pertinence indicator with regard to the given media content. Alternatively, a value ‘1’ denotes a highest value for the pertinence indicator with regard to the given media content.

It will be appreciated that each of the plurality of items of media content is analysed with regard to pertinence indicators associated thereto. Subsequently, a value is determined for each of pertinence indicators for each of the plurality of items of media content.

Moreover, the server arrangement may analyse each of the pertinence indicators for the given media content to assign a weight thereto. In this regard, a weight for a pertinence indicator defines an importance of the pertinence indicator in determination of the quality prediction score for the given media content. S weight for a pertinence indicator may be a numerical value, wherein the numerical value may be positive or negative. Beneficially, weighing each of the pertinence indicators for each of the plurality of items of media content gives greater importance to more accurate and more relevant pertinence indicators. Subsequently, weighing the pertinence indicators of the given media content makes determination of quality prediction score for the given media content more accurate and unbiased. A weight for a pertinence indicator may vary for the different data sources. The weighting for each item of media content is re-assessed in real-time by taking into account how that item of media content is performing in the data sources where it has been published.

The server arrangement determines the quality prediction score for each of the plurality of items of media content, wherein the quality prediction score for items of media content is determined based on values of pertinence indicators for the media content. Notably, the term “quality prediction score” refers to a numerical value or a point obtained upon relative processing of values for each of the pertinence indicators for the given media content. Notably, the quality prediction score for the given media content defines a value of the given media content when used by the user operating the user device. The quality prediction score may be a numerical value on a scale of 1 to 100, wherein a score ‘1’ denotes a lowest score and a score ‘100’ denotes a highest score. Furthermore, in an embodiment, the quality prediction score is generated upon determining an average of the values of each of the pertinence indicators for the given media content. In another embodiment, the quality prediction score is generated upon determining a weight multiplier for each of the pertinence indicators of the given media content. Subsequently, a weight multiplier for a pertinence indicator is multiplied with a value of the pertinence indicator to get an aggregate value thereof. Similarly, each of the pertinence indicators for the given media content are processed to determine aggregate value associated therewith. Such aggregate values of the pertinence indicators associated with the given media content are averaged to determine the quality prediction score for the given media content.

The server arrangement further may calibrate the quality prediction score for an item of media content by:
identifying an associated item of media content, wherein the associated item of media content is similar to the item of media content; and
determining a calibrated quality prediction score for the media content based on a performance index of the associated item of media content.

In this regard, the server arrangement may identify the associated item of media content for the media content (namely, the given media content). Specifically, the associated item of media content resembles the given media content in, for example, appearance, quality, character, content, format and the like. In an instance, associated media content for the given media content, wherein the given media content is a social media post posted (namely, uploaded) by a given contributor, may be a social media post posted by a contributor, wherein the contributor is similar to the given contributor (for example, in the numbers of followers or territorial reach); a social media post that is output to an audience similar to the audience of the user operating the user device (for example, audience of the same age, gender, from the same geographical region or with the same interests); a social media post that is similar to posts previously output by the user operating the user device; a social media post having content similar to content in the given media content; or a combination thereof.

Furthermore, the server arrangement may determine the performance index for the associated item of media content. In an instance, the performance index for the associated item of media content is determined based on parameters describing how the associated item of media content performed among masses or audience. The parameters for performance index may include, but are not limited to, popularity of the associated item of media content, likes on the associated item of media content, dislikes on the associated item of media content, interactions with the associated item of media content, a number of times the associated item of media content is viewed/searched, territorial reach and so forth.

Subsequently, the server arrangement may determine the calibrated quality prediction score for the given media content based on the performance index of the associated item of media content. In this regard, the server arrangement determines a weight for the associated item of media content with regard to the given media content. Such weight of the associated item of media content may depend on, for example, a level of similarity between the associated item of media content and the given media content. It will be appreciated that weight for the associated item of media content will be higher if it is more similar to the given media content. Moreover, it will be appreciated that the calibrated prediction score for the given media content is dependent on the quality prediction score of the given media content and the performance index of the associated item of media content.

It will be appreciated that the given media content may have a plurality of associated media content related thereto. Subsequently, the server arrangement determines a weight for each of the plurality of associated media content. Furthermore, the server arrangement determines the calibrated quality prediction score for the given media content based on quality prediction score for the given media content and performance index of the plurality of associated media content related to the given media content.

It is to be understood that the server arrangement determines associated media content for each of the plurality of items of media content identified based on the service request. Notably, quality prediction score for each of the plurality of items of media content is re-calibrated based on the calibrated quality prediction score associated therewith. Typically, such determination of calibrated quality prediction score for items of media content based on associated media content is a convoluted and elaborate task that requires a lot of manual effort and time. Beneficially, such task is performed by the system to provide greater reliability and value in any decision for selection of media content from the plurality of items of media content, wherein the plurality of items of media content is an enormous pool of media contents.

The server arrangement may provide a filtered set of items of media content on the user device, in response to the service request, wherein the set of items of media content comprises at least one item of media content having a quality prediction score higher than a predefined threshold. It will be appreciated that a quality prediction score for each of the plurality of items of media content is determined by the server arrangement. Subsequently, the server arrangement determines a threshold quality prediction score for the service request, with regard to quality prediction score for each of the plurality of items of media content. Such threshold enables the server arrangement to create a subset of items of media content that comprises at least one item of media content having quality prediction score higher than the determined threshold. Beneficially, determining the threshold and further the subset of items of media content reduces time for curation of desirable media content by automatically selecting media content having high quality prediction score that apprises a quality thereof. Henceforth, user operating the user device is provided with the subset of items of media content comprising best quality media content that can be used as a powerful endorsement for products, services, brands, and the like.

The server arrangement may determine the subset of items of media content based on the quality prediction score for each of the plurality of items of media content and calibrated quality prediction score associated therewith.

The server arrangement may employ machine learning algorithms to determine the quality prediction score for each of the plurality of items of media content. Specifically, the ‘machine learning algorithms’ refer to a category of algorithms employed by the server arrangement that allows the sever arrangement to become more accurate in determining the quality prediction score for each of the plurality of items of media content, without being explicitly programmed. More specifically, the machine learning algorithms are employed to train the server arrangement so as to enable the server arrangement to automatically learn, from analysing training dataset and improve performance from experience, without being explicitly programmed.

The server arrangement may be trained using different types of machine learning algorithms, depending upon the training dataset employed. Typically, examples of the different types of machine learning algorithms, depending upon the training dataset employed for training the server arrangement comprise, but are not limited to: supervised machine learning algorithms, unsupervised machine learning algorithms, semi-supervised learning algorithms, and reinforcement machine learning algorithms. Furthermore, the server arrangement is trained by interpreting patterns in the training dataset and adjusting the machine learning algorithms accordingly to get a desired output. Moreover, the server arrangement may be trained to determine a weight of a pertinence indicator and a value for the pertinence indicator.

The machine learning algorithms employed for determining the quality prediction score for items of media content may be trained by monitoring a performance index of the media content. In this regard, the server arrangement monitors usage of a given media content, wherein the given media content is selected from the plurality of items of media content. The given media content may be selected from the subset of items of media content provided to the user device. Moreover, the user of the user device may select the given media content to upload thereto as, for example, a social media post. Subsequently, performance index of the given media content is monitored in regular intervals to check effectiveness thereof. The performance index of the given media content may be monitored once in 10 minutes, once in 24 hours, once in a week, or once in a month. The performance index of the given media content may be monitored in real-time. Such performance index for the given media content is monitored by monitoring parameters such as likes on the given media content, dislikes on the given media content, rating provided to the given media content, review for the given media content, interactions with the given media content, and the like. Subsequently, the machine learning algorithms are trained based on the performance index of the given media content.

Moreover, the present description also relates to the method as described above. The various embodiments and variants disclosed above apply mutatis mutandis to the method.

The method further may comprise calibrating the quality prediction score for an item of media content by:
identifying an associated item of media content, wherein the associated item of media content is similar to the item of media content; and
determining a calibrated quality prediction score for the media content based on a performance index of the associated item of media content.

The method may comprise providing a filtered set of items of media content on the user device, in response to the service request, wherein the set of items of media content comprises at least one item of media content having a quality prediction score higher than a predefined threshold.

The method may comprise employing machine learning algorithms to determine the quality prediction score for each of the plurality of items of media content.

The machine learning algorithms may be employed for determining the quality prediction score for items of media content are trained by monitoring a performance index of the media content.

### DETAILED DESCRIPTION OF THE DRAWINGS

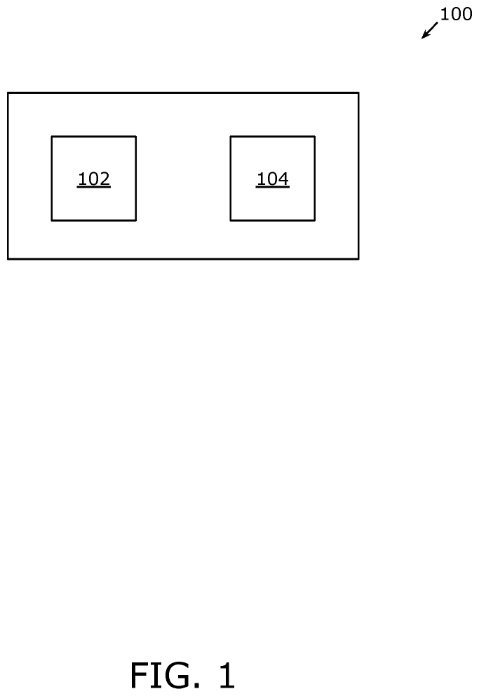

Referring to FIG. 1, there is shown schematic illustration of an environment 100 in which a server arrangement 102 for providing media content to a user device is implemented, in accordance with an embodiment of the present disclosure. The server arrangement 102 is communicably coupled to a user device 104. The server arrangement 102 is configured to execute machine readable instructions that cause the server arrangement 102 to identify, in response to a service request from the user device 104, a plurality of items of media content from at least one data source related to the service request, analyse the plurality of items of media content to determine values of pertinence indicators for each of the plurality of items of media content; determine a quality prediction score for each of the plurality of items of media content, wherein the quality prediction score for items of media content is determined based on values of pertinence indicators for the media content; and provide a filtered set of items of media content to the user device, in response to the service request. The set of items of media content comprises at least one item of media content having a quality prediction score higher than a predefined threshold.

FIG. 1 is merely an example, which should not unduly limit the scope of the claims herein. It is to be understood that the simplified illustration of the server arrangement 102 is provided as an example and is not to be construed as limiting the environment 100 to specific numbers, types, or arrangements of the processing arrangement. A person skilled in the art will recognize many variations, alternatives, and modifications of embodiments of the present disclosure.

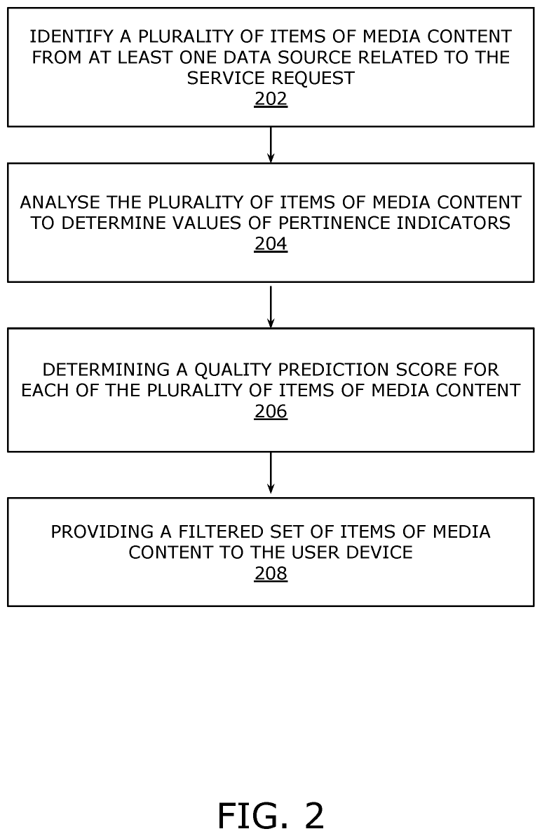

Referring to FIG. 2, it illustrates steps of a method for providing media content to a user device, in accordance with an embodiment of the present disclosure. The method is depicted as a collection of steps in a logical flow diagram, which represents a sequence of steps that can be implemented in hardware, software, or a combination thereof, for example as aforementioned.

The method for providing media content to a user device is implemented via a system comprising a server arrangement communicably coupled to a user device. The server arrangement is configured to execute machine readable instructions. At a step 202, in response to a service request from the user device, a plurality of items of media content are identified from at least one data source related to the service request. At a step 204, the plurality of items of media content are analysed to determine values of pertinence indicators for each of the plurality of items of media content. At a step 206, a quality prediction score for each of the plurality of items of media content is determined. At a step 208, a filtered set of items of media content is provided to the user device, in response to the service request. Notably, the set of items of media content comprises at least one item of media content having a quality prediction score higher than a predefined threshold.

The steps 202, 204, 206 and 208 are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1.-13. (canceled)

14. A server arrangement for providing media content to a user device, wherein the server arrangement is configured to execute machine readable instructions that cause the server arrangement to:
in response to a service request from the user device, identify a plurality of items of media content from at least one data source related to the service request;
analyse the plurality of items of media content to determine values of pertinence indicators for each of the plurality of items of media content;
determine a quality prediction score for each of the plurality of items of media content, wherein the quality prediction score for items of media content is determined based on values of pertinence indicators for the media content;
provide a filtered set of items of media content to the user device, in response to the service request, wherein the set of items of media content comprises at least one item of media content having a quality prediction score higher than a predefined threshold.

15. The server arrangement of claim 14, wherein the server arrangement is further configured to calibrate the quality prediction score for an item of media content by:
identifying an associated item of media content, wherein the associated item of media content is similar to the item of media content; and
determining a calibrated quality prediction score for the media content based on a performance index of the associated item of media content.

16. The server arrangement of claim 14, wherein the server arrangement is further configured to determine the pertinence indicators for each of the plurality of items of media content, wherein the pertinence indicators are based on the type of each respective item of media content.

17. The server arrangement of claim 14, wherein the server arrangement employs machine learning algorithms to determine the quality prediction score for each of the plurality of items of media content.

18. The server arrangement of claim 17, wherein machine learning algorithms employed for determining the quality prediction score for items of media content are trained by monitoring a performance index of the provided media content.

19. A system comprising the server arrangement of claim 14 and a user device, wherein the user device is configured to:
send a service request to the server arrangement;
in response to receiving filtered set of items of media content from the server output, providing the items of media content for output to a user for moderation; and
in response to a user selection of one or more items of media content, providing the selected content items for output to a network of recipients.

20. A method for providing media content to a user device, wherein method comprises:
in response to a service request from the user device, identifying a plurality of items of media content from at least one data source related to the service request;
analysing the plurality of items of media content to determine values of pertinence indicators for each of the plurality of items of media content;
determining a quality prediction score for each of the plurality of items of media content, wherein the quality prediction score for items of media content is determined based on values of pertinence indicators for the media content;
providing a filtered set of items of media content to the user device, in response to the service request, wherein the set of items of media content comprises at least one item of media content having a quality prediction score higher than a predefined threshold.

21. The method of claim 20, wherein the method further comprises calibrating the quality prediction score for an item of media content by:
identifying an associated item of media content, wherein the associated item of media content is similar to the item of media content; and
determining a calibrated quality prediction score for the media content based on a performance index of the associated item of media content.

22. The method of claim 20, wherein the method comprises determining the pertinence indicators for each of the plurality of items of media content, wherein the pertinence indicators are based on the type of each respective item of media content.

23. The method of claim 20, wherein the method comprises employing machine learning algorithms to determine the quality prediction score for each of the plurality of items of media content.

24. The method of claim 23, wherein the machine learning algorithms employed for determining the quality prediction score for items of media content are trained by monitoring a performance index of the provided media content.

25. The method of claim 14 and a user device, wherein the user device is configured to:
send a service request to the server arrangement;
in response to receiving filtered set of items of media content from the server output, providing the items of media content for output to a user for moderation; and
in response to a user selection of one or more items of media content, providing the selected content items for output to a network of recipients.

26. A computer program product comprising non-transitory computer-readable storage media having computer-readable instructions stored thereon, the computer-readable instructions being executable by a computerized device comprising processing hardware to execute a method of claim 20.
